(19) United States
(12) Patent Application Publication
(10) Pub. No.: US 2025/0038334 A1
(43) Pub. Date: Jan. 30, 2025

(54) BATTERY ASSEMBLY BASE PORTION

(71) Applicant: JAGUAR LAND ROVER LIMITED, Whitley (GB)

(72) Inventors: Niall SHIMMIN, Coventry (GB); Sujit CHATTERJEE, Birmingham (GB); John JACKSON, Coventry (GB); Sainjal SOLLY, Coventry (GB); Vlad PACURARI, Coventry (GB)

(21) Appl. No.: 18/361,231

(22) Filed: Jul. 28, 2023

(51) Int. Cl. H01M 50/244; B23K 9/025; H01M 50/204; H01M 50/227; H01M 50/249; H01M 50/271

(52) U.S. Cl. CPC H01M 50/244; B23K 9/025; H01M 50/204; H01M 50/227; H01M 50/249; H01M 50/271; B60L 50/64; H01M 2220/20

(57) ABSTRACT

A battery assembly base portion, comprising a base plate comprising a base plate top surface and side edges, and a siderail comprising a siderail top surface and an inner edge. A weld groove is formed in one of the inner edge of the siderail and a side edge of the base plate. The siderail is attached to the base plate by a weld bead formed along the weld groove such that the base plate top surface and the siderail top surface are flush with one another.

### TECHNICAL FIELD

The present disclosure relates to a battery assembly base portion in which a siderail is attached to a base plate by a weld bead. First and second siderails may be attached on opposed sides of the base plate. The present disclosure also relates to a battery assembly comprising such a base portion and a sealant layer disposed over the weld beads. In particular, but not exclusively, the battery assembly may relate to a high voltage battery of a fully electric or hybrid vehicle. Thus, in addition, the present disclosure relates to a vehicle comprising a battery assembly as disclosed. The present disclosure also relates to methods of assembling a battery assembly base portion and methods of assembling a battery comprising such a base portion.

### BACKGROUND

High voltage batteries are incorporated into fully electric and hybrid vehicles as either a primary or secondary energy source.

Such high voltage batteries typically comprise a base portion and a lid portion, together providing a cavity. The high voltage batteries may be releasably mounted to a vehicle, such as to a sill of the vehicle.

It is an aim of the present invention to address one or more of the disadvantages associated with the prior art.

### SUMMARY OF THE INVENTION

Aspects and embodiments of the invention provide a battery assembly base portion and a method of assembling a battery assembly base portion. Aspects and embodiments of the invention also provide a method of assembling a battery assembly comprising the battery assembly base portion. Aspects and embodiments of the invention further provide a vehicle comprising a body component, and a battery assembly secured to the vehicle body component.

According to an aspect of the present invention there is provided a battery assembly base portion, comprising: a base plate comprising a top surface and side edges; and a siderail comprising a siderail top surface and an inner edge. A weld groove is formed in one of the inner edge of the siderail and a side edge of the base plate. The siderail is attached to the base plate by a weld bead formed along the weld groove such that the base plate top surface and the siderail top surface are flush with one another.

The inventors have determined that the weld beads could be left undressed if a weld bead protrudes sufficiently shallowly above the top surfaces of the base plate and the siderail such that a sealant layer retains a sufficient sealing performance, and this is achieved through the formation of the weld groove along which the welding then takes place. The weld groove may be formed in either one of the side edges of the base plate or the inner edge of the siderail, in either case at the respective edge thereof that lies adjacent the corresponding side edge of the other, where they form an interface.

The weld groove may be formed at an angle of approximately 35° relative to an interface between the inner edge of the siderail and the side edge of the base plate. Advantageously, this angle has been shown to minimise the height of protrusion of the resulting weld bead above the top surfaces.

The weld groove may be approximately 2 mm deep.

In certain embodiments, the weld groove further comprises a flat bottom portion adjacent said interface. Providing a flat bottom portion may help to mitigate undercutting of the weld.

The weld bead may have a maximum height above the top surfaces of the base plate and the siderail of <1.5 mm.

In certain embodiments, the battery assembly base portion comprises siderails attached to each of the base plate side edges, each including an interface between the inner edge of the respective siderail and the side edge of the base plate and an associated weld groove.

According to aspects of the invention, there is provided a battery assembly comprising the base portion as described above and a sealant layer disposed over the weld beads.

The sealant layer may comprise a modified silane polymer adhesive, such as Teroson MS 930. Adhesives in this class cure via exposure to moisture (e.g. atmospheric moisture) and are thus applied in liquid form, which is tolerant to the presence of minor protrusions in the surface to which it is applied. Moreover, such sealants are tolerant of impurities in the weld bead surface due to sooting.

Optionally, the battery assembly may further comprise a lid portion secured to the base portion, the lid portion including a flange circumscribing a lower end thereof and overlying the weld beads when secured in place.

vehicle comprising a body component; and a battery assembly as described above secured to the body component.

According to aspects of the invention, there is provided a method of assembling a battery assembly base portion, the method comprising: providing a base plate having a top surface and side edges; providing a siderail having a siderail top surface and an inner edge; forming a weld groove in one of the inner edge of the siderail and a side edge of the base plate; aligning the siderail and the base plate such that the base plate top surface and the siderail top surface are flush with one another; and attaching the siderail to the base plate by forming a weld bead along the weld groove.

Optionally, the base plate has first and second opposed side edges; providing a siderail comprises providing a first siderail having a first siderail top surface and a first siderail inner edge, and providing a second siderail having a second siderail top surface and a second siderail inner edge; forming a weld groove comprises forming a first weld groove in one of the first siderail inner edge and the first side edge of the base plate, and forming a second weld groove in one of the second siderail inner edge and the second side edge of the base plate; aligning the siderail and the base plate comprises aligning the first and second siderails and the base plate such that the base plate top surface and the respective first and second siderail top surfaces are flush with one another; and attaching the siderail comprises attaching the first and second siderails to the base plate by forming respective first and second weld beads along the respective first and second weld grooves. Thus, a battery base portion comprising a base plate and two siderails on opposed side edges of the base plate can be constructed.

Optionally, forming the weld groove comprises forming the weld groove at an angle of approximately 35° relative to an interface between the inner edge of the siderail and the side edge of the base plate.

Forming the weld groove may comprise forming the weld groove to a depth of approximately 2 mm.

Forming the weld groove may comprise forming a flat bottom portion adjacent said interface.

According to certain embodiments, the weld bead has a maximum height above the top surfaces of the base plate and the siderail of <1.5 mm.

Forming the weld bead may comprise arc welding. The weld bead is thus typically continuous along the length of the weld groove.

According to aspects of the invention, there is provided a method of assembling a battery assembly, the method comprising: assembling a battery assembly base portion as described above—optionally where the battery base plate is attached to first and second siderails on opposed sides thereof; and disposing a sealant layer over the weld beads.

The disposing of the sealant layer over the weld beads may be done without prior dressing of the weld beads. Due to the relatively low protrusion height of the weld beads, the sealant layer is able to accommodate the height variation in the top surfaces to which it is applied without compromising on seal integrity.

The method of assembling a battery assembly may further comprise securing a lid portion to the base portion, the lid portion including a flange circumscribing a lower end thereof and overlying the weld beads when secured in place. Thus a battery assembly may be constructed using the techniques described above for constructing the battery assembly base portion.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a cross-section through part of an exemplary battery assembly as mounted to a vehicle sill;

FIG. 2 shows a cross-section through a nominal welded joint along a weld groove having a 45° angle to a plane of intersection between a base plate and a siderail;

FIG. 3 shows the same joint as FIG. 2, but with a gap between the base plate and the siderail, illustrating an additional amount of weld material to fill the gap;

FIG. 4A corresponds to FIG. 2, but shows the additional weld material of FIG. 3 on the top surface of the joint;

FIG. 4B corresponds to FIG. 4A, but shows a semi-circular profile to the weld bead rather than the rectangular profile of FIG. 4A;

FIG. 5 shows a cross-section through a nominal welded joint along a weld groove having a 35° angle to a plane of intersection between a base plate and a siderail and including a flat bottom portion adjacent said intersection;

FIG. 6 shows the same joint as FIG. 5, but with a gap between the base plate and the siderail, illustrating an additional amount of weld material to fill the gap;

FIG. 7A corresponds to FIG. 5, but shows the additional weld material of FIG. 6 on the top surface of the joint;

FIG. 7B corresponds to FIG. 7A, but shows a semi-circular profile to the weld bead rather than the rectangular profile of FIG. 7A;

FIG. 8 is a photograph of a cross-section through a test weld along a weld groove having a 35° angle to a plane of intersection between the test components;

FIG. 9 shows a process diagram for a method of assembling a battery assembly base portion according to one aspect of the invention; and

FIG. 10 shows a process diagram for a method of assembling a battery assembly according to another aspect of the invention.

### DETAILED DESCRIPTION

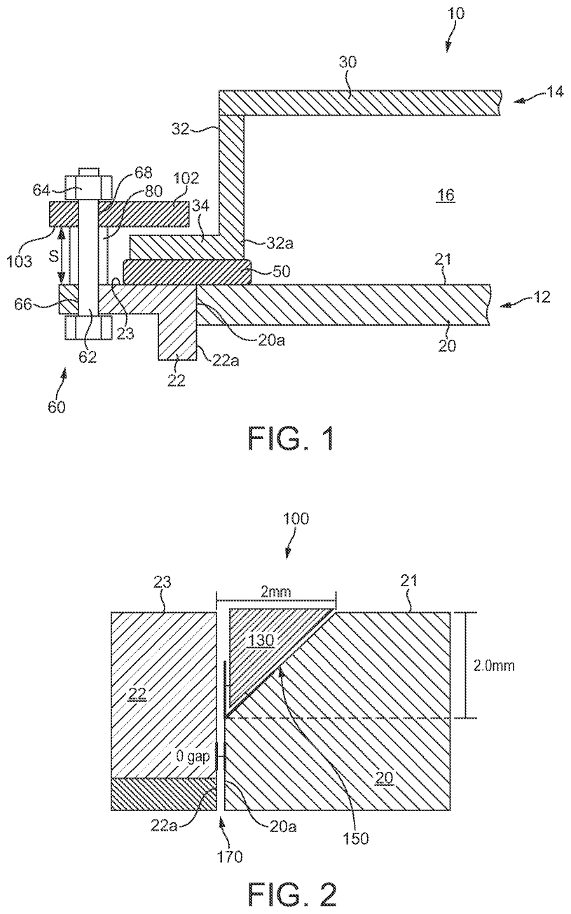

A high voltage battery assembly 10 typically comprises a base portion 12 and a lid portion 14, together defining a cavity 16 for receiving battery cells (not shown), as illustrated by reference to FIG. 1. The base portion 12 may comprise a substantially planar base plate 20 surrounded by a plurality of base frame members 22. The lid portion 14 typically comprises a substantially planar top portion 30, substantially parallel to the base plate 20, and substantially vertical walls 32 extending downwardly therefrom towards the base plate. A flange or rim 34 extends outwardly from a bottom end 32a of the walls 32, circumscribing the bottom end of the lid portion 14. Fasteners (not shown) secure the lid portion 14 to the base portion 12. A layer of sealant 50 is sandwiched between the base portion 12 and the lid portion 14 in order to ensure the integrity of their affixation and to seal the cavity 16.

Such a high voltage battery assembly 10 may be releasably mounted to a vehicle (not shown), such as to body component 102—typically a sill, and may form part of the vehicle structure. A releasable mounting provides for ease of servicing and replacement of the battery assembly 10. One convenient mechanism for releasably mounting the battery assembly 10 to the body component 102 is to use threaded fasteners 60, such as bolts 62 and associated nuts 64, as shown in schematic form in the accompanying FIG. 1. Conventionally, this has been done by passing a series of bolts 62 through associated holes 66 in the base frame members 22, through corresponding holes 68 in the body component 102 (e.g. the sill) and threading a nut 64 on to the threaded end 62a of each bolt, torquing to predefined specifications. A defined separation ‘S’ between a bottom surface 103 of the body component 102 and an upper surface 23 of the underlying base frame members 22 is necessary to provide space in which to accommodate, for example, the heads of the fasteners securing the lid portion 14 to the base portion 12, manufacturing tolerances, panel overlaps, different thicknesses of the sealant layer 50, etc. Moreover, a certain separation S is required in order to allow access for a cutting tool to cut through the sealant layer during servicing operations. This defined separation S is ensured by placing collars 80 of defined height in the gap between the battery assembly 10 and the body component 102.

It is important for the battery base portion 12 to be well constructed, particularly if to be used as an integral part of a vehicle's structure when mounted. Accordingly, the attachment of the siderails 22 to the base plate 20 must be solid. For this reason, the siderails 22 are normally attached to the base plate 20 by continuous weld beads, formed by an arc-welding operation.

However, the resulting weld beads are variable and can lie significantly proud (i.e. >1.5 mm) of the respective upper surfaces 21, 23 of the base plate 20 and the siderails 22, which can cause problems for the integrity of the seal provided by the sealant layer 50 as applied over that region. Accordingly, to date, prior to application of the sealant layer and assembly of the lid portion 14 to the base portion 12, the weld beads have been ‘dressed’—i.e. ground back to provide a substantially flush upper surface at an interface between the sides of the base plate 20 and the respective siderails 22. The grinding back may be done via CNC machine operation, but there are significant hardware costs and associated space requirements. Alternatively, the weld beads may be ground down manually, for example through use of an angle grinder tool, but this requires a tool operator and an associated workstation on the assembly line. Dressing the weld beads also removes impurities (‘sooting’) deposited on the weld bead surface during the arc welding process. Thus, the sealant layer laid over the resulting dressed weld beads can take many different compositions and forms, including both wet and dry scaling media.

FIG. 2 shows a cross-section through a nominal welded joint 100 attaching a siderail 22 to a base plate 20. The joint 100 comprises a weld bead 130 along a half-V weld groove 150 formed at a lateral edge 20a of the base plate. The weld groove 150 may be approximately 2 mm deep. The weld groove 150 has a 45° angle to a plane of intersection 170 between the base plate 20 and the siderail 22. For a nominal welded joint 100 where there is zero gap between the base plate 20 and the siderail 22, a nominal volume of weld material is required in order to fill the weld groove 150 such that an upper surface 132 of the weld bead 130 is flush with the respective upper surfaces 21, 23 of the base plate 20 and the siderail 22.

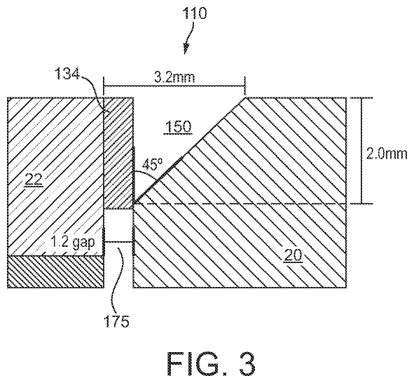

However, due to variations in manufacturing and assembly and associated tolerances, there may be a small gap 175 at the interface between the base plate 20 and the siderail 22. A gap 175 of up to approximately 1.2 mm can be within tolerance. When such a gap 175 is present, an additional quantity of weld material 134 is needed for the weld bead 130 to fill the gapped joint 110, as illustrated by reference to FIG. 3.

It is typical for the welding process to attach the siderail 22 to a base plate 20 to be at least semi-automated. Accordingly, a nominal volume of weld material is required to be determined so that the automated process may be carried out effectively. To this end, the determined volume must account for gapped joints 110 as well as for nominal joints 100 with no gap. Thus, the nominal volume of weld material may be calculated as the sum of the volume required to fill the weld groove 150 to be flat—i.e. flush with the respective upper surfaces 21, 23 of the base plate 20 and the siderail 22—then plus the volume required to fill the maximum allowable gap 175.

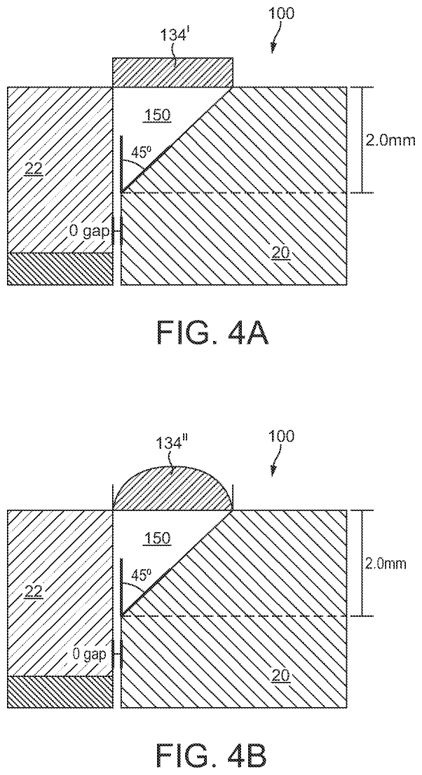

As illustrated by reference to FIGS. 4A and 4B, where that determined nominal volume of weld material is applied to a nominal joint 100 with no gap present, the additional volume of weld material 134 is effectively displaced to lie on top of the weld groove 150. In FIG. 4A, the additional weld material is modelled as deposited in the form of an ideal rectangle 134′. With a weld groove 150 having a 45° angle, the height of that additional rectangle of material 134′ above the respective upper surfaces 21, 23 of the base plate 20 and the siderail 22 is the same as the width of the maximum permissible gap 175—i.e. up to approximately 1.2 mm. In FIG. 4B, the additional weld material is modelled as deposited in the form of an ideal semi-circle 134″, which represents a worst case scenario in respect of additional height of weld material. For the same conditions, the height of that additional semi-circle of material 134″ above the respective upper surfaces 21, 23 of the base plate 20 and the siderail 22 is up to approximately 1.53 mm.

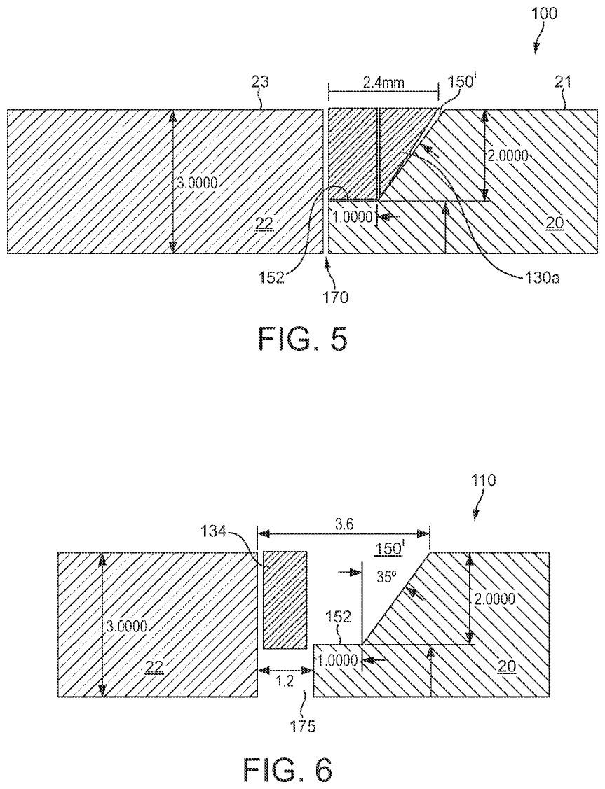

A steeper weld groove 150 with an angle of approximately 35° relative to the plane of intersection 170 between the base plate 20 and the siderail 22 mitigates the risk of a welding undercut and minimises the height of protrusion of the resulting weld bead 130 above the flush surfaces 21,23 when welding a joint 110 having a maximum permissible joint gap 175. In certain embodiments, the weld groove further comprises a flat bottom portion 152 adjacent the joint interface, and thus takes the form of a stepped weld groove 150′. FIGS. 5 to 7B, which mirror FIGS. 2 to 4B illustrate such a groove 150′.

As shown in FIG. 5, as applied to a nominal joint 100 with no gap at the plane of intersection 170, the volume of weld material can be calculated based on the cross-sectional area of the stepped weld groove 150′, and in this instance comprises a first portion 130a associated with filling the triangular region above the 35° side of the groove, and a second portion 130b associated with filling the rectangular region above the flat bottom portion 152. For a weld groove depth of 2 mm, and with a flat bottom portion 152 that is 1 mm in width, the width of the top of the groove 150′ at the upper surfaces 21,23 is 2.4 mm. Thus, the area of the first portion 130a is 1.4 mm² and the area of the second portion 130b is 2.0 mm², resulting in a total cross-sectional area of 3.4 mm². Where, as shown in FIG. 6, a joint 110 has a maximum permissible gap 175 of 1.2 mm, an additional quantity of weld material 134 is needed for the weld bead 130 to fill the gapped joint 110. In this instance, the cross-section of the additional quantity of weld material 134 is 2.4 mm².

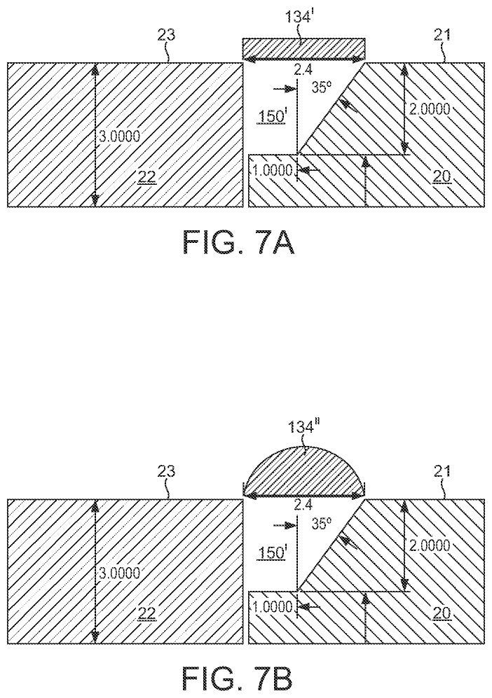

As illustrated by reference to FIGS. 7A and 7B, where the associated determined nominal volume of weld material is applied to a nominal joint 100 with no gap present, the additional volume of weld material 134 is effectively displaced to lie on top of the weld groove 150′. In FIG. 7A, the additional weld material is modelled as deposited in the form of an ideal rectangle 134′. Since the width of the weld groove 150′ at the upper end, flush with the respective upper surfaces 21, 23 of the base plate 20 and the siderail 22 is 2.4 mm, the height of that additional rectangle of material 134′ above the respective upper surfaces 21, 23 is approximately 1.0 mm. In FIG. 7B, the additional weld material is modelled as deposited in the form of an ideal semi-circle 134″, which represents a worst case scenario in respect of additional height of weld material. For the same conditions, the height of that additional semi-circle of material 134″ above the respective upper surfaces 21, 23 of the base plate 20 and the siderail 22 is up to approximately 1.27 mm.

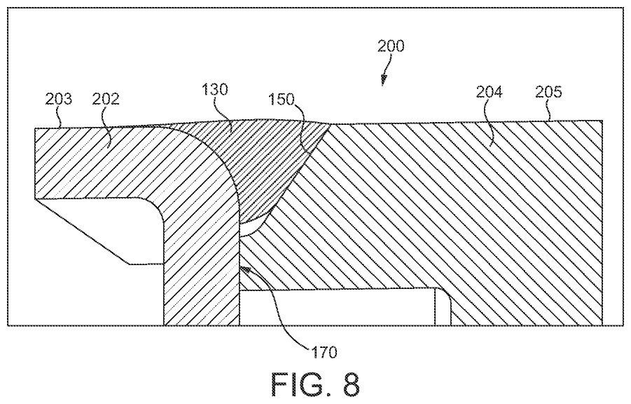

FIG. 8 is a photograph of a cross-section through a test weld 200 along a weld groove 150 having a 35° angle to a plane of intersection 170 between first and second test components 202,204. It can be seen that the resulting weld bead 130 projects only very shallowly above the respective upper surfaces 203,205 of the test components.

Preparing the geometry of the joint region by providing a half-V weld groove 150 or a stepped half-V groove 150′ in this manner allows for a strong weld joint to be formed whilst minimising the height of the associated weld bead 130. The maximum height of the weld bead 130 above the respective top surfaces 21,23 of the base plate 20 and the siderail 22 can thus be kept below approximately 1.5 mm.

With such a minimised weld bead height and by using a selected class of sealant that is applied in liquid form over the resulting joint 100; 110 and which is thus tolerant to the presence of minor protrusions in the surface to which it is applied, the resulting sealant layer 50 retains a sufficient sealing performance even if the weld bead 130 is not machined or ground back to being flush with the respective upper surfaces 21,23 of the base plate 20 and siderail 22. A modified silane polymer adhesive, such as Teroson MS 930 has been determined as suitable. Moreover, such sealants are tolerant of impurities in the weld bead surface due to sooting.

The sealing performance is tested according to industry standard pressure tests that apply a positive pressure to the cavity 16 of an assembled battery assembly 10.

FIG. 1 illustrates just one side of a battery assembly, and the associated attachment of a single siderail 22 to one lateral side edge of the base plate 20. It will be appreciated that the battery assembly may be substantially symmetrical, with the base plate 20 having first and second siderails 22 attached thereto on opposed side edges thereof. The attachment of the second siderail 22 would be as described above by reference to the single siderail. Furthermore, additional battery base portion components, such as cross members (not shown) may be attached to the base plate 20 in an analogous manner.

Whereas the weld groove 150; 150′ has been described as being formed in the side edge 20a or edges of the base plate 20, it will be understood that it could instead be formed in the facing inner edge 22a of the or each siderail 22.

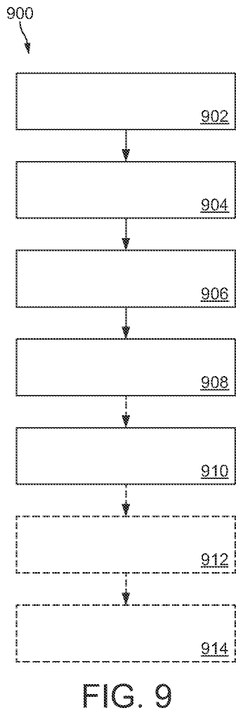

As illustrated by reference to FIG. 9, a battery assembly base portion 12 may thus be assembled using a method 900 comprising: providing 902 a base plate 20 having a top surface 21 and side edges 20a; providing 904 a siderail 22 having a siderail top surface 23 and an inner edge 22a; forming 906 a weld groove 150; 150′ in one of the inner edge 22a of the siderail 22 and a side edge 20a of the base plate 20; aligning 908 the siderail 22 and the base plate 20 such that the base plate top surface 21 and the siderail top surface 23 are flush with one another; and attaching 910 the siderail 22 to the base plate 20 by forming a weld bead 130 along the weld groove 150; 150′.

Once the battery assembly base portion 12 has been constructed, the sealant layer 50 may be applied, in liquid form. The method 900 thus may further comprise disposing 912 a sealant layer over the weld bead 130. Optionally, the battery assembly 10 may further comprise a lid portion 14 secured to the base portion 12, the lid portion 14 including a flange 34 circumscribing a lower end 32a thereof and overlying the weld beads 130 when secured in place. Accordingly, the method 900 may further comprise securing 914 a lid portion 14 to the base portion 12. Securing 914 the lid portion 14 to the base portion 12 sandwiches the sealant layer 50 between the flange 34 and the welded joint region. Thus, the method 900 may comprise a method of assembling a battery assembly 10.

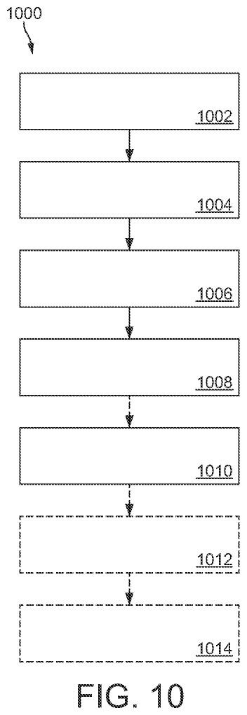

A corresponding method 1000 of assembling a battery assembly base portion 12 having both first and second siderails 22 is illustrated by reference to FIG. 10. The base plate 20 has first and second opposed side edges 20a. The method 1000 corresponds to the method 900 described by reference to FIG. 9, but providing 1002 a siderail 22 comprises providing a first siderail 22 having a first siderail top surface 23 and a first siderail inner edge 22a, and providing a second siderail 22 having a second siderail top surface 23 and a second siderail inner edge 22a; forming 1004 a weld groove 150; 150′ comprises forming a first weld groove 150; 150′ in one of the first siderail inner edge 22a and the first side edge 20a of the base plate, and forming a second weld groove 150; 150′ in one of the second siderail inner edge 22a and the second side edge 20a of the base plate; aligning 1006 the siderail and the base plate comprises aligning the first and second siderails 22 and the base plate 20 such that the base plate top surface 21 and the respective first and second siderail top surfaces 23 are flush with one another; and attaching the siderail comprises attaching the first and second siderails 22 to the base plate 20 by forming respective first and second weld beads 130 along the respective first and second weld grooves 150; 150′. Thus, a battery base portion 12 comprising a base plate 20 and two siderails 22 on opposed side edges of the base plate can be constructed.

As with the method of FIG. 9, once the battery assembly base portion 12 has been constructed, the sealant layer 50 may be applied, in liquid form. The method 1000 thus may further comprise disposing 1012 a sealant layer over the weld beads 130. The method 1000 may likewise further comprise securing 1014 a lid portion 14 to the base portion 12. Securing 1014 the lid portion 14 to the base portion 12 sandwiches the sealant layer 50 between the flange 34 and the welded joint regions. Thus, the method 1000 may comprise a method of assembling a battery assembly 10.

In either instance, the weld beads 130 may be formed by arc welding.

The disposing 912; 1012 of the sealant layer 50 over the weld beads 130 may be done without prior dressing of the weld beads. Due to the relatively low protrusion height of the weld beads, the sealant layer is able to accommodate the height variation in the top surfaces 21,23 to which it is applied without compromising on seal integrity.

The completed battery assembly 10 may be secured to a vehicle, for example by securing to a body component thereof.

It will be appreciated that various changes and modifications can be made to the present invention without departing from the scope of the present application.

1. A battery assembly base portion, comprising:
a base plate comprising a base plate top surface and side edges; and
a siderail comprising a siderail top surface and an inner edge;
wherein a weld groove is formed in one of the inner edge of the siderail and a side edge of the base plate; and
wherein the siderail is attached to the base plate by a weld bead formed along the weld groove such that the base plate top surface and the siderail top surface are flush with one another.

2. The battery assembly base portion as claimed in claim 1, wherein the weld groove is at an angle of approximately 35° relative to an interface between the inner edge of the siderail and the side edge of the base plate.

3. The battery assembly base portion as claimed in claim 2, wherein the weld groove is approximately 2 mm deep.

4. The battery assembly base portion as claimed in claim 2, wherein the weld groove further comprises a flat bottom portion adjacent said interface.

5. The battery assembly base portion as claimed in claim 1, wherein the weld bead has a maximum height above the top surfaces of the base plate and the siderail of <1.5 mm.

6. The battery assembly base portion as claimed in claim 1, comprising siderails attached to each of the base plate side edges, each including an interface between the inner edge of the respective siderail and the side edge of the base plate and an associated weld groove.

7. A battery assembly comprising the battery assembly base portion as claimed in claim 6 and a sealant layer disposed over the weld bead.

8. The battery assembly as claimed in claim 7, wherein the sealant layer comprises a modified silane polymer adhesive.

9. The battery assembly as claimed claim 7, further comprising a lid portion secured to the battery assembly base portion, the lid portion including a flange circumscribing a lower end thereof and overlying the weld bead when secured in place.

10. A vehicle comprising:
a body component; and
the battery assembly as claimed in claim 9 secured to the body component.

11. A method of assembling a battery assembly base portion, the method comprising:
providing a base plate having a base plate top surface and side edges;
providing a siderail having a siderail top surface and an inner edge;
forming a weld groove in one of the inner edge of the siderail and a side edge of the base plate;
aligning the siderail and the base plate such that the base plate top surface and the siderail top surface are flush with one another; and
attaching the siderail to the base plate by forming a weld bead along the weld groove.

12. The method of assembling a battery assembly base portion as claimed in claim 11, wherein:
the base plate has first and second opposed side edges;
providing a siderail comprises providing a first siderail having a first siderail top surface and a first siderail inner edge, and providing a second siderail having a second siderail top surface and a second siderail inner edge;
forming a weld groove comprises forming a first weld groove in one of the first siderail inner edge and the first side edge of the base plate, and forming a second weld groove in one of the second siderail inner edge and the second side edge of the base plate;
aligning the siderail and the base plate comprises aligning the first and second siderails and the base plate such that the base plate top surface and respective first and second siderail top surfaces are flush with one another; and
attaching the siderail comprises attaching the first and second siderails to the base plate by forming respective first and second weld beads along respective first and second weld grooves.

13. The method of assembling a battery assembly base portion as claimed in claim 11, wherein forming the weld groove comprises forming the weld groove at an angle of approximately 35° relative to an interface between the inner edge of the siderail and the side edge of the base plate.

14. The method of assembling a battery assembly base portion as claimed in claim 13, wherein forming the weld groove comprises forming the weld groove to a depth of approximately 2 mm.

15. The method of assembling a battery assembly base portion as claimed in claim 14, wherein forming the weld groove comprises forming a flat bottom portion adjacent said interface.

16. The method of assembling a battery assembly base portion as claimed in claim 11, wherein the weld bead has a maximum height above the top surfaces of the base plate and the siderail of <1.5 mm.

17. The method of assembling a battery assembly base portion as claimed in claim 11, wherein forming the weld bead comprises arc welding.

18. A method of assembling a battery assembly, the method comprising:
assembling the battery assembly base portion as claimed in claim 12; and
disposing a sealant layer over the first and second weld beads.

19. The method of assembling a battery assembly as claimed in claim 18, wherein the disposing of the sealant layer over the first and second weld beads is done without prior dressing of the first and second weld beads.

20. The method of assembling a battery assembly as claimed in claim 18, further comprising securing a lid portion to the battery assembly base portion, the lid portion including a flange circumscribing a lower end thereof and overlying the first and second weld beads when secured in place.
